(19) United States
(12) Patent Application Publication
(10) Pub. No.: US 2006/0040398 A1
(43) Pub. Date: Feb. 23, 2006

(54) Method and apparatus for forming a dilution by fluid dispersion

(76) Inventors: Craig M. Schulz, Thousand Oaks, CA (US); Leslie A. Walling, Newbury Park, CA (US); Michael Johnson, Newbury Park, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/185,944

(22) Filed: Jul. 21, 2005

Related U.S. Application Data
(60) Provisional application No. 60/589,827, filed on Jul. 22, 2004.

(51) Int. Cl. B01L 3/00

(52) U.S. Cl. 436/43; 436/180; 422/63; 422/100

(57) ABSTRACT

According to one aspect of the invention, a method of creating a dilution series is provided. The method may include providing a first vessel including a sample, and aspirating at least a portion of the sample from the first vessel into a first conduit primed with solvent such that the sample disperses in the solvent. At least a portion of the dispersed sample is dispensed into a second vessel while, substantially simultaneously, a solvent is dispensed into the second vessel from a second conduit. Alternatively, the second vessel may already contain the solvent and the first conduit may dispense the dispersed sample into the second vessel containing the solvent. According to one aspect of the invention, a system for creating a dilution series is provided. The system may include a first conduit configured to aspirate and dispense a sample to be diluted and a second conduit configured to dispense a solvent. First and second pressure sources may be provided to move fluid through the respective first and second conduits. The system may also include a controller configured to instruct the first and second pressure sources to dispense an aspirated sample and solvent at substantially the same time.

This application claims priority under 35 U.S.C. § 119 based on U.S. Provisional Application No. 60/589,827, filed Jul. 22, 2004, the complete disclosure of which is incorporated herein by reference.

### FIELD OF THE INVENTION

The present invention relates to automated fluid handling and transfer, and more particularly to the automated formation of a dilution series by dispersive dilution.

### BACKGROUND OF THE INVENTION

Dilution plates are generally prepared by either serial dilution or direct deposit. In a 96 well plate having 12 columns, with two columns being blank control columns, dilutions series can be created, for example a 2:1 dilution series. This means that 10 columns containing sample will ultimately be provided, wherein each column contains half or fifty percent as much sample as the preceding column.

In serial dilution, a compound of interest having a known concentration at a set volume is diluted in a solvent. In this example, prior to initiation of the dilution, column 1 would contain the compound of interest at a known concentration and of a given volume, for example, 200 μL and the remaining (non-control) columns would each contain 100 μL of pure solvent, for example, dimethyl sulfoxide (DMSO). The serial dilution begins by aspirating 100 μL of the sample from column 1 and dispensing the aspirated sample into column 2. The resulting solution in column 2 (100 μL of sample and 100 μL of solvent) is mixed by repeated pipetting (i.e., aspirating and dispensing). After mixing, 100 μL is aspirated from column 2. Column 2 now contains a solution in which the concentration of the sample is half that of the concentration of the sample in column 1. The 100 μL aspirated from column 2 is dispensed into column 3 and is mixed. The process is repeated throughout the rest of the plate (skipping the control columns and discarding 100 μL from the final column), to achieve a 2:1 dilution series in 100 μL total. Preferably, pipette tips should be changed between each column. As is known in the art, different dilution series, e.g., 3:1, 5:1, require aspiration and dispensing of different volumes of sample.

The creation of the dilution series can be performed by hand or it can be an automated process, performed for example, by a Tecan Genesis RSP 200. When performed by hand, the process is time consuming and fatiguing to the operator. There is inconsistency between users, and higher density formats are extremely difficult, in both mixing and potentially missed wells. However, this method is considered the gold standard. When performed by automation, the process is slow in that it requires filling all wells with solvent prior to performing the dilution, as well as the time necessary for tip changes. In addition, serial dilutions are susceptible to the propagation of error, as each subsequent dilution is dependent upon the concentration of the preceding column, thus an error in one column will be propagated throughout the remainder of the columns.

In direct deposit dilution, a precise amount of the compound of interesvsample is deposited in each well. Each well is then topped off with solvent, such that each well contains the same volume, for example, 100 μL. Thus, to begin a 2:1 dilution series, for example, the first column would contain 100 μL of sample, the second column would contain 50 μL of sample and 50 μL of solvent, the third column would contain 25 μL of sample and 75 μL of solvent, with each column thereafter containing half as much sample as the preceding column and 50% more solvent as the preceding column, such that the tenth column would contain 0.195 μL of sample and 99.805 μL of solvent.

Unlike serial dilutions, the concentration in each well is independent of concentration in every other column. This reduces carryover error and makes the dilutions more accurate than serial dilution. There is the potential for error from additional sample clinging to the outside of the delivery tips. The sample to be added to each column is taken from column 1, which contains the sample at a high concentration. Any carryover from the tip could significantly alter the concentration in one of the later wells, especially wells in columns 9 or 10, which have a very low concentration of sample. In addition, for the volume of the dilution series described above, (100 μL), a liquid handler would be required to accurately dispense between 195 nL and 100 μL. Such a range is beyond most liquid handlers. In addition, the volumes required for direct deposit dilution span a larger range as the dilution factor increases, for example, to a 5:1 dilution. If small volume dispensers are used, large amounts of time would be needed to achieve large volumes and would require multiple dispenses.

Thus, there is a need for a method of creating a series dilution that is relatively fast, works within the ranges of conventional liquid handlers, and reduces the amount of carryover error.

### SUMMARY OF THE INVENTION

In accordance with the invention, an apparatus and method for creating a dilution series using fluid dispersion is provided.

According to one aspect of the present invention, a method of creating a dilution series is provided. The method includes providing a plurality of vessels, wherein at least a first vessel includes a sample, aspirating at least a portion of the sample from at least the first vessel into at least one first conduit primed with solvent such that the sample disperses in the solvent, dispensing at least a portion of the dispersed sample from the at least one first conduit into at least a second vessel, and substantially simultaneously dispensing a solvent into at least the second vessel from at least one second conduit.

According to another aspect of the invention, a system for creating a dilution series is provided. The system includes at least one first conduit configured to aspirate and dispense a sample to be diluted, a first pressure source, configured to prime the at least one first conduit with a solvent and configured to aspirate a sample into the primed first conduit, wherein the first pressure source provides laminar flow conditions that cause the sample to disperse in the solvent in the at least one first conduit, at least one second conduit configured to dispense a solvent, a second pressure source for dispensing a solvent from the at least one second conduit, and a controller configured to instruct said first and second pressure sources to dispense said aspirated sample and said solvent at substantially the same time.

According to yet another aspect of the present invention, a method of creating a dilution series includes providing a plurality of vessels, providing a sample in at least a first vessel, aspirating at least a portion of the sample into at least one first conduit, permitting the aspirated sample to disperse into solvent contained within the at least one first conduit, wherein dispersion of the sample occurs at least by convection, dispensing a portion of the dispersed sample from the at least one first conduit into at least a second vessel, and dispensing a solvent into at least the second vessel from at least one second conduit.

According to a further aspect of the present invention, a method of creating a dilution series includes providing a plurality of vessels, providing a sample in at least a first vessel, aspirating at least a portion of the sample into at least one first conduit, permitting the aspirated sample to disperse into solvent contained within the at least one first conduit, dispensing a portion of the dispersed sample from the at least one first conduit into at least a second vessel, and washing a tip of the at least one first conduit by substantially simultaneously dispensing a solvent into at least the second vessel from at least one second conduit that surrounds the at least one first conduit.

According to yet another aspect of the present invention, a method of creating a dilution series using a pressure driven pumping syringe based liquid handler is provided. The method includes providing a plurality of vessels, wherein at least a first vessel includes a sample and at least a second vessel includes a diluent, aspirating a diluent into at least one conduit, aspirating at least a portion of the sample from at least the first vessel into the at least one conduit containing the aspirated diluent such that the sample disperses in the diluent, and dispensing at least a portion of the dispersed sample from the at least one conduit into at least the second vessel containing the diluent to form a dilution of the sample.

According to a further aspect of the present invention, a method of creating a dilution series using a pressure driven pumping syringe based liquid handler, comprises providing a plurality of vessels, wherein at least a first vessel includes a sample and at least a second vessel includes a diluent, aspirating at least a portion of the sample into at least one conduit, permitting the aspirated sample to disperse into diluent contained within the at least one conduit, dispensing a first portion of the dispersed sample from the at least one conduit into a waste receptacle, and dispensing a second portion of the dispersed sample from the at least one conduit into at least the second vessel.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1 is an isometric view of a system for automatically creating a dilution series, according to the present invention;

FIG. 2 is an isometric view of a portion of the system of FIG. 1;

FIG. 3 is an isometric view of the manifold containing first and second tubes of the system of FIG. 1, according to the present invention;

FIG. 4 is a top view of the portion of the system shown in FIG. 2;

FIG. 5 is a front view of the portion of the system shown in FIG. 2;

FIG. 6A is a cross-sectional view of a tube containing solvent prior to aspirating a sample;

FIG. 6B is a cross-sectional view of the tube of FIG. 6A containing a solvent into which a sample has been aspirated and dispersed, according to one aspect of the present invention;

FIG. 6C is the cross-sectional view of the tube of FIG. 6B, wherein lines have been added to represent the volume slicing of the dispersion curve (i.e., the dispersed sample);

FIG. 7 is a top view of an embodiment of a plurality of vessels, according to one aspect of the present invention; and

FIG. 8 is an isometric view of an alternative embodiment of a manifold and dispensing portion of a system to be used to practice a method according to the present invention.

### DESCRIPTION OF THE EMBODIMENTS

Reference will now be made in detail to the present embodiments of the invention, examples of which are illustrated in the accompanying drawings. Wherever possible, the same reference numbers will be used throughout the drawings to refer to the same or like parts.

The present invention provides a method and system for formation of a dilution series. As used herein, the term dilution “series” may encompass a single dilution or several dilutions created from a sample. The method minimizes the time needed to create a dilution series. The method and system disperse the sample and the solvent simultaneously, eliminating the need to separately “top off” wells after sample has been placed in the wells. In addition, the system may utilize a unique configuration of the sample tube nesting within the solvent tube. This nesting design mixes the solvent and sample, eliminating the need for sequential mixing of the solvent and sample and provides a washing effect, washing off any sample drops that might remain on the end of the sample tube into the well. This has three benefits: the flushing reduces error that can be caused by sample remaining on tubing, it allows much smaller volumes to be dispensed, and it makes the exchange of tips between wells unnecessary.

The method of the present invention aspirates a sample once and then dispenses the aspirated (and diluted) sample repeatedly, for example, nine times for a 10 point dilution. The time to create such a dilution series according the present invention is approximately 90 seconds. This time is significantly shorter than prior art methods, which may take up to eight minutes. In addition, the accuracy of the dilution series formed by a method according to the present invention has been checked against hand calibrated dilution series. The accuracy of the dilution series created according to the method of the present invention may vary from hand calibrated values by less than ±4%. This is significantly more accurate than prior art methods. Finally, the dispersion technique used by the method of the present invention is highly reproducible both between channels and from plate-to-plate.

The method and apparatus of the present invention also permit variation of the dilution factor within a given dilution series or plurality of vessels. Such a capability is useful to give additional data points within a selected portion of the dilution series. Such a variation of the dilution factor can be achieved by dispensing a portion of the dispersed sample at a first dilution factor, subsequently changing the dilution factor (e.g., by eliminating a portion of the dispersed sample), and then dispensing the dispersed sample at the new dilution factor.

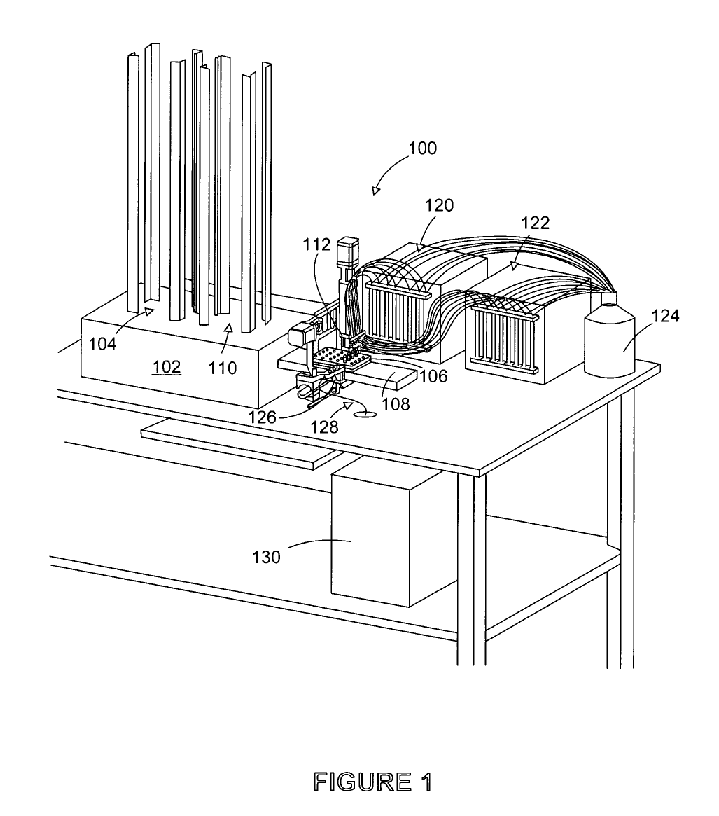

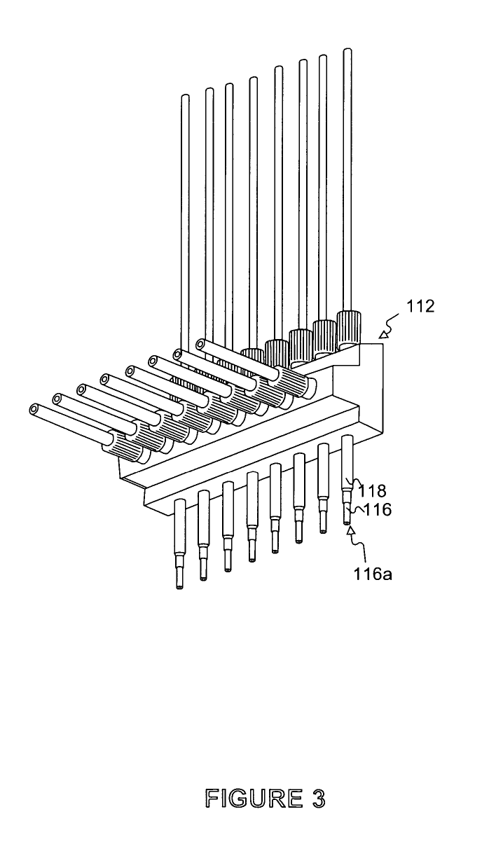

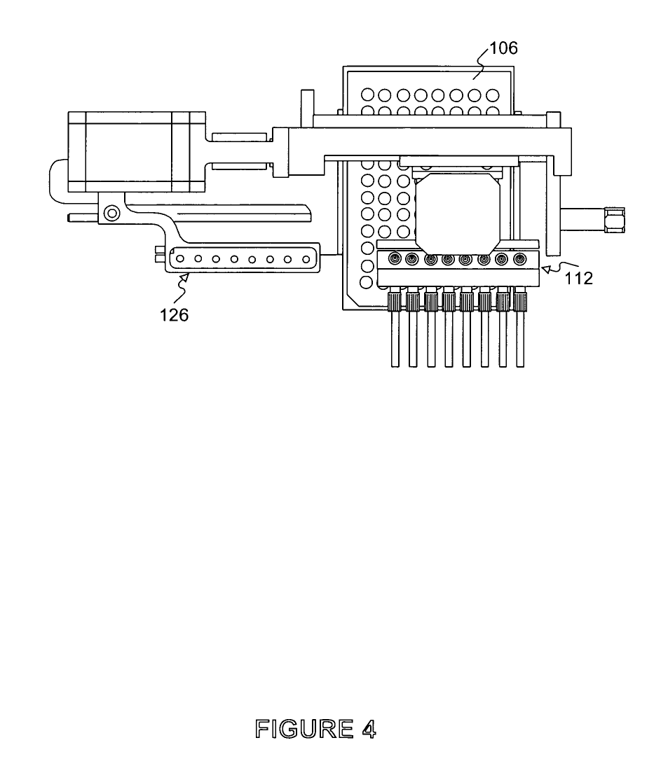

According to one aspect of the invention, a system for automatically forming a dilution series is provided. As shown in FIGS. 1-4 and embodied herein, the system 100 may include a vertical plate stacker, a plurality of fluid channels, a first set of syringe pumps, a second set of syringe pumps, a washing station, and means for controlling the system.

As shown in FIGS. 1-4, the system 100 may include a vertical stacker 102. The vertical stacker may be any conventional stacker suitable for receiving/storing, and dispensing a plurality of vessels, for example, microtiter plates containing a plurality of wells. The stacker should also have a platform on which to manipulate the plates in the x-direction to address individual columns of wells. In one embodiment, a PerkinElmer PlateStak™ was used. Alternatively, fixed plates articulated by robotic handling and a movable manifold may be used. As embodied herein, the stacker 102 includes an input area 104 for receiving and storing a plurality of plates 106, each plate 106 including a plurality of vessels or wells 106a, each plate containing a sample in, for example, the first column or first row of vessels 106a. Plates 106 may be any conventional microtiter plate, such as a 96 well plate or a 384 well plate. Plates 106 are moved from the input area 104 to a track portion 108 on which they are translated while they are filled. After being filled, plates 106 are moved from track portion 108 to an output area 110 where they are stored for later use. The stacker should be configured to store, dispense, and manipulate standard SBS-footprint microtiter plates. (Society for Biomolecular Screening, www.sbsonline.org/msdc/pdf/ANSI SBS 1-2004.pdf) Any conventional microtiter plate may be used with this system. For example, 96 well and 384 well microtiter plates may be used. Alternatively, plates with a greater or lesser density of wells may be used.

In one embodiment, the stacker 102 stores plates 106 that were previously separately prepared with a sample(s) of interest in each well of a first column of wells. If so desired, an apparatus that fills the wells in the first column (or first row, or other column(s) or row(s)) with the sample may be added to the system 100 to fill the wells and be controlled by the system controller to be transported to the stacker 102 for storage until needed for a dilution series.

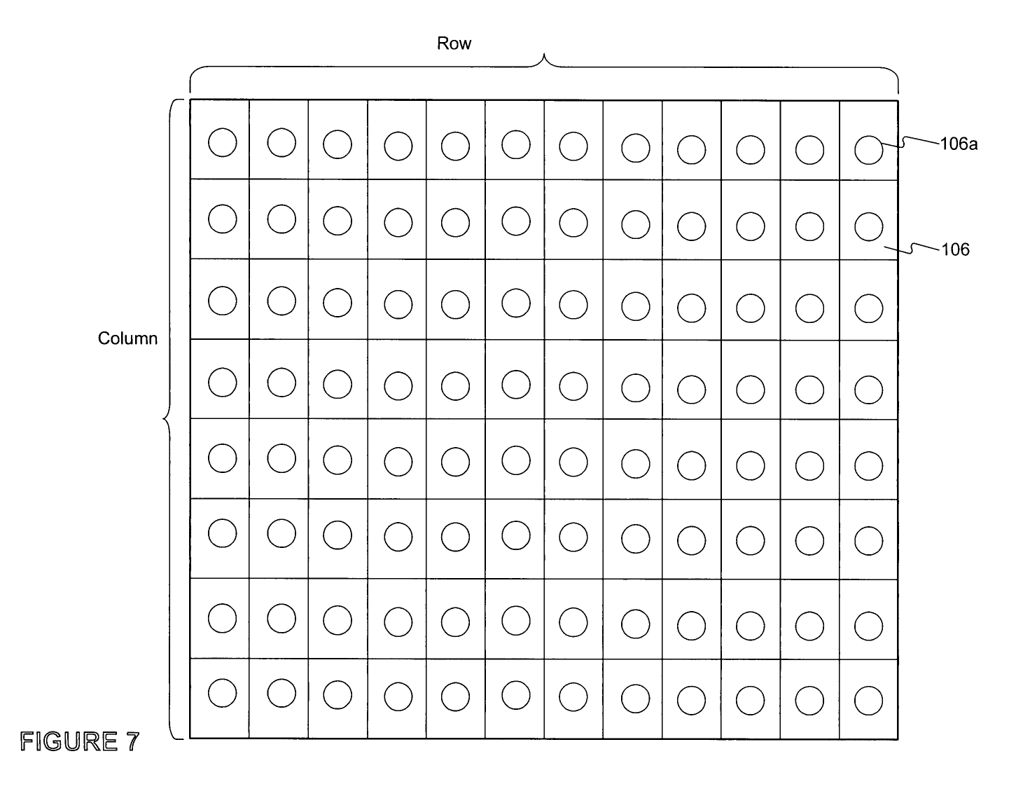

Although the invention is described below in the context of creating a series dilution using microtiter plates each having a plurality of vessels, it should be understood that any type of structure suitable to hold a liquid could be used, such as, for example, racks of test tubes or microtubes, or disposable liners containing a plurality of depressions. In each of these examples, the plurality of vessels may be arranged in rows and columns as shown in FIG. 7.

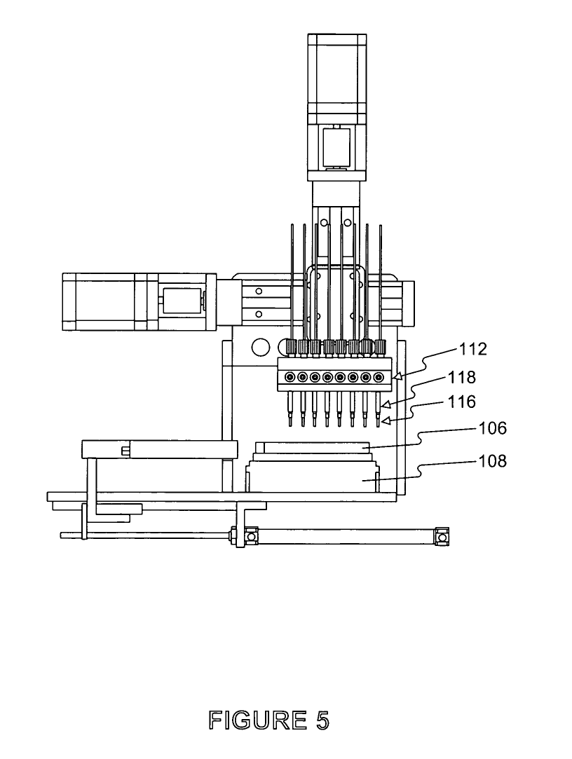

According to another aspect of the invention, the system 100 may include a plurality of fluid channels (not shown). As embodied herein and shown in FIGS. 1-5, the plurality of fluid channels may be in a common block, or manifold 112. In one embodiment, the manifold 112 includes eight (8) fluid channels. Additional or fewer fluid channels may be used to adapt the function of the device to various applications. The manifold 112 may be movable in a z-direction (i.e., adjustable height). The movement may be provided by any suitable means, such as by a stepper motor. The manifold 112 may also be movable from side to side, in a y-direction. The side to side movement may be provided by any suitable means, such as by a stepper motor. The y-direction movement permits the system to be used to fill vessels spaced far apart from one another or positioned very closely to one another, such as for example, the vessels in a 384 well plate (not shown). The spacing between the fluid channels may be such, for example, that each fluid channel is configured to line up with a well in a given column of a 96 well plate. In a 384 well plate, each fluid channel may line up with every other well in a given column of the plate. Thus, in order to fill all wells in a given column of a 384 well plate, it is necessary to provide a means for the manifold 112 to translate in a direction transverse to the stacker track 108 so that it lines up with the remaining wells in a given column.

Each fluid channel includes a first conduit, for example, a first tube 116 made out of a suitable material, such as PEEK. Each first tube 116 is centralized and may be nested within a second conduit, for example a second tube 118. Second tube 118 may be made out of stainless steel or any other suitable material. The first tube 116 may have any suitable inner diameter. In one embodiment, the first tubes 116 each have an inner diameter of 0.02 inches and an outer diameter of 0.063 inches. Selection of alternative outer diameters will not affect calibration of the system, however, alternate inner diameters may require recalibration of the system from the parameters that will be provided herein. Such recalibration should be within the ordinary skill in the art. The inner diameter of the second tubes 118 must be of sufficient size to contain the first tube 116 and to permit fluid to pass between the inside of the second tube 118 and the outside of the first tube 116, as will be described below. In one embodiment, the second tubes 118 each have an inner diameter of 0.071 inches and the first tubes 116 have an outer diameter of 0.063 inches, leaving a gap of 0.004 inches between the first and second tubes. Both the first tubes 116 and the second tubes 118 should be of sufficient length to reach from the manifold 112 to a respective pump. First and second conduits may have cross-sections of a variety and shapes and sizes, although round cross-sections may be preferred. In addition, the first and second conduits may be straight, curved, coiled or of other suitable geometry. The conduit that contains the dispersed sample must be long enough to contain all sample so that the dilution parabola is not perturbed by the pump mechanism.

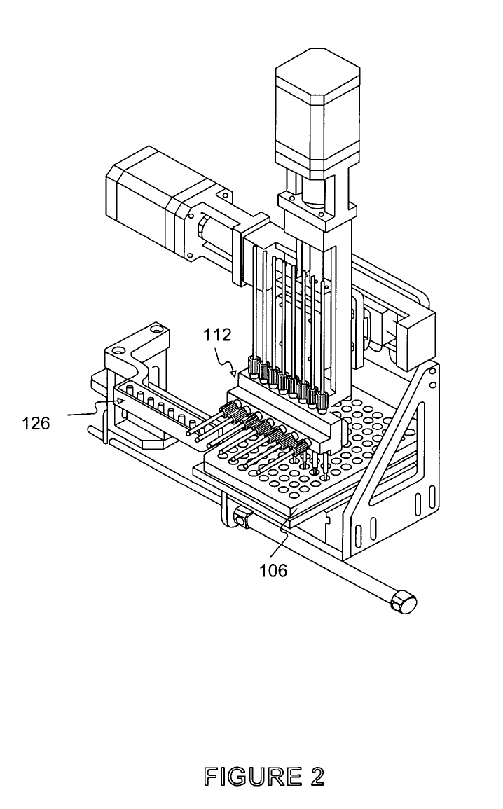

As shown in FIG. 2, first tubes 116 extend through and out of second tubes 118, for example, by approximately 0.15 to 0.3 inches and in one embodiment by 0.236 inches. The difference in heights between the base or tip 116a of the first tube 116 and the base or tip 118a of the second tube 118 was selected to prevent the tips 118a of the second tubes 118 from coming into contact with any solution in the wells of the plates 106 or with any solution in a wash station, to be described later. Other suitable distances between the tip 118a and the tip 116a may be used.

Alternatively, the first conduit may not be nested within the second conduit, and instead may be positioned near the second conduit. In such an embodiment, the second conduit is positioned relative to the first conduit, such that fluid exiting from the second conduit is directed around at least a tip portion of the first conduit.

Although less preferred, it is possible to practice a method according to the present invention with a system that does not include a second conduit. Such an embodiment is less preferred because the process takes longer and may require rinsing of the outside of the tips. However, such an embodiment provides the benefit of permitting the method of the present invention to be practiced using conventional commercial pressure driven pumping syringe based liquid handlers, such as the Tecan Genesis RS 200, without modification.

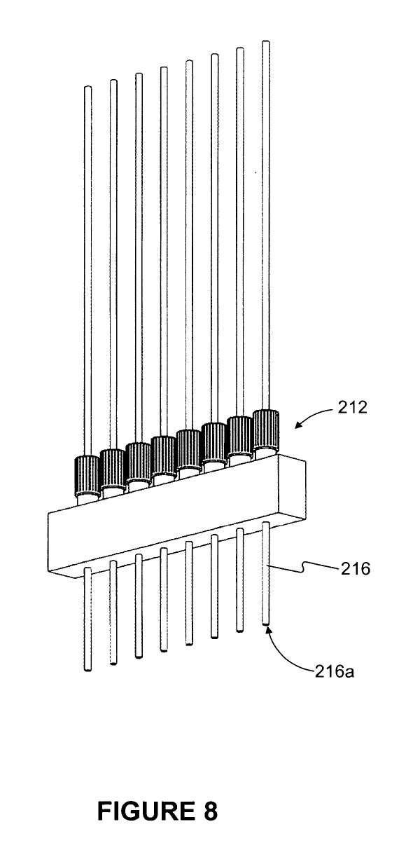

As embodied herein and shown in FIG. 8, the conventional handler may include a common block or manifold 212. Manifold 212 includes a plurality of fluid channels (not shown). The number of fluid channels may be selected as necessary to adapt the function of the device to various applications. Manifold 212 may be movable and driven as discussed above, or by other conventional means. Each fluid channel includes a first conduit, for example, a first tube 216 made out of a suitable material, such as PEEK. The first tube 216 may have any suitable inner diameter as described above. Selection of alternate inner diameters may require recalibration of the system from the parameters that will be provided herein. Such recalibration should be within the ordinary skill in the art. The first tubes 216 should be of sufficient length to reach from the manifold 212 to a respective pump. First conduits 216 may have cross-sections of a variety and shapes and sizes, although round cross-sections may be preferred. In addition, the first conduits 216 may be any suitable geometry. The first conduit 216 will contain the dispersed sample and therefore must be long enough to contain all sample so that the dilution parabola is not perturbed by the pump mechanism.

According to another aspect of the present invention, the system 100 may include first and second pressure sources. Any suitable type of pressure source, such as for example, pressure driven pumps, may be used. In a preferred embodiment first and second banks 120,122 of pressure driven pumps may include ganged syringe pumps. As embodied herein and shown in FIGS. 1-5, the first tubes 116, 216 may be connected to the respective outputs of a first bank 120 of ganged syringe pumps, the output of each syringe pump being connected to one of first tubes 116,216. The second tubes 118 may be connected to the respective outputs of a second bank 122 of ganged syringe pumps, the output of each syringe pump being connected to one of second tubes 118. The size of the syringes limits the volume dispensed into the wells. Thus, the smaller the syringes, the smaller the potential final volume of the dilution series. The input of each syringe pump of the first and second banks 120, 122 of pumps is connected to a solvent feed, such as a container of DMSO. The first and second banks 120, 122 of ganged syringe pumps are run by internal motors, such as stepper motors, which are controlled by a computer 130.

According to one aspect of the present invention, the system 100 may include a washing station 126. The washing station may be configured to receive the tips 116a of first tubes 116. The first and second tubes may be washed by flushing the system with solvent from the solvent feed 124, such that solvent is dispensed from first and second tubes 116,118 into the washing station. As the solvent flows out of second tubes 118, it washes the tips 116a of first tubes 116. Coincidently or alternately, the wash station actively pumps fluid up through its wells to keep the wash fluid uncontaminated. The wash station is then drained via vacuum into a waste receptacle by drain 128. Wash station 126 and first and second tubes are movable relative to one another to position the wash station under the first tubes. In one embodiment, the wash station 126 is movable to be extended across track portion 108 to wash the tips 116a. After washing, wash station 126 is retracted from track portion 108 in order to permit manipulation of well plates on the track portion 108.

According to one aspect of the invention, a controller for system 100 is provided. As embodied herein, the controller may include a computer 130 or other suitable instrument control means. Computer 130 may be provided with a plurality of protocols from which a user of the system may select the type of dilution series to be created. For example, one variable factor is the dilution factor: a user may select between, for example, a 2:1, a 3:1, a 5:1, a 800:1, a 1600:1, a 2400:1, and a 25000:1 dilution series. Alternatively, it is possible to program the computer to switch between dilution factors in a single dilution series. For example, a portion of a dilution series may be prepared as a 2:1 dilution and the remainder may be prepared as a 5:1 dilution.

Another variable factor is the final volume of the dilution series. In the examples provided herein, the final volume is 100 μL. However, other final volumes such as, for example, 50 μL and 10 μL may be selected by a user. Another variable is the solvent used. For example, a user may select between DMSO and an aqueous solvent, such as a buffer. Other suitable types of solvents may be used. Another variable is the size and type of the plurality of vessels used. For example, a user may select between a 96 well microtiter plate and a 384 well microtiter plate. Vessels of other sizes and/or shapes, such as for example, racks of test tubes or microtubes, or disposable liners containing a plurality of depressions. For each set of variables selected, the computer may contain a database which lists the amount of dispersed sample and the amount of solvent to be dispensed at each point in the dilution. Tables of exemplary databases are shown below.

Dispensed volumes to create IC50 dilutions
(Dispensed volumes are in microliters)
SOLVENT = DMSO (96 well plate)

| Dilution ratio | 2 to 1 | 3 to 1 | 3 to 1 | 3 to 1 | 3 to 1 | 3 to 1 | 3 to 1 | 3 to 1 | 5 to 1 |
|---|---|---|---|---|---|---|---|---|---|
| Final volume (μL) | 50 | 100 | 80 | 66.7 | 50 | 40 | 33.3 | 26.7 | 96 |
| Column 2 | 26.4 | 38 | 30.4 | 23.6 | 19.1 | 15.3 | 12.7 | 10.2 | 23.3 |
| Column 3 | 15.5 | 30.8 | 21.9 | 15.7 | 11.8 | 8.9 | 7.4 | 6 | 19 |
| Column 4 | 13 | 36 | 28.8 | 22.2 | 16.6 | 13.3 | 11.3 | 8.9 | 15.4 |
| Column 5 | 11.2 | 28.8 | 27.9 | 21.6 | 16.2 | 13 | 11.4 | 8.6 | 5.2 |
| Column 6 | 8.2 | 18.4 | 21.1 | 15.5 | 12.2 | 9.7 | 8.4 | 6.5 | 1.1 |
| Column 7 | 5 | 8.5 | 12.5 | 10.4 | 7.8 | 5.9 | 5.1 | 4 | 0.3 |
| Column 8 | 2.8 | 3.3 | 7.4 | 4.6 | 3.5 | 2.8 | 2.3 | 1.9 | 5.3*mix |
| Column 9 | 1.4 | 1.1 | 2.8 | 1.4 | 1.1 | 0.8 | 0.6 | 0.6 | 1.3 |
| Column 10 | 0.7 | 0.6 | 0.5 | 0.3 | 0.2 | 0.2 | 0.2 | 0.2 | 0.3 |

SOLVENT = DMSO (384 well plate)

| | |
|---|---|
| Dilution ratio | 3 to 1 |
| Final volume (μL) | 40 |
| Column 2 | 14.9 |
| Column 3 | 9 |
| Column 4 | 12.8 |
| Column 5 | 11.6 |
| Column 6 | 10 |
| Column 7 | 5.3 |
| Column 8 | 2.2 |
| Column 9 | 0.7 |
| Column 10 | 0.2 |

SOLVENT = Aqueous (96 well plate)

| | |
|---|---|
| Dilution ratio | 3 to 1 |
| Final volume (μL) | 100 |
| Column 2 | 38 |
| Column 3 | 32.5 |
| Column 4 | 33 |
| Column 5 | 21.5 |
| Column 6 | 12.8 |
| Column 7 | 6.1 |
| Column 8 | 2.5 |
| Column 9 | 0.9 |
| Column 10 | 0.3 |

SOLVENT = Aqueous (384 well plate)

| | |
|---|---|
| Dilution ratio | 3 to 1 |
| Final volume (μL) | 40 |
| Column 2 | 16.8 |
| Column 3 | 10.9 |
| Column 4 | 8.9 |
| Column 5 | 6 |
| Column 6 | 3.4 |
| Column 7 | 1.3 |
| Column 8 | 6 *MIX |
| Column 9 | 2.1 |
| Column 10 | 0.6 |

*mix= dispense 20 uL of top off buffer/DMSO into well and aspirate 10 uL into the sample tubes to re-disperse the sample profile
*MIX = dispense 20 uL of top off buffer/DMSO into well and aspirate 10 uL into the sample tubes to re-disperse the sample profile

The principle of operation for the method of the present invention is based upon dispersion of a sample into a carrier stream. The phenomenon of dispersion is based upon at least two components, convection currents introduced by the pressure driven syringe pump and sample diffusion. To begin, sample is aspirated into the first tubes, primed with solvent, from vessels arranged in a first column or row. As the aspirated sample is drawn into the first tube primed with solvent, convection results in the sample bolus taking on a substantially parabolic flow profile as it moves through the first tube 116, with the fluid adjacent the tube walls moving at a slower rate (due to friction with the walls) than the fluid in the center of the tube due to the influence of laminar flow. As the sample traverses the tube and becomes elongated due to its parabolic flow profile, the original concentration of the sample becomes diluted in the solvent.

Diffusion also plays a role in the dispersion of the sample into the solvent within the tube. Molecules will migrate from an area of higher concentration to an area of lower concentration by the process of diffusion. Thus, as the sample takes on the parabolic flow profile molecules of the sample can diffuse between the different layers of the flow profile, increasing the dispersion effect. The diffusion plays a relatively small role in the dispersion of the sample when compared to the convection that is driven by the pressurized pumping. Irreversible laminar folding, eddy currents, tube surface interactions and conduit geometry may be other factors affecting the amount of dispersion seen by the system.

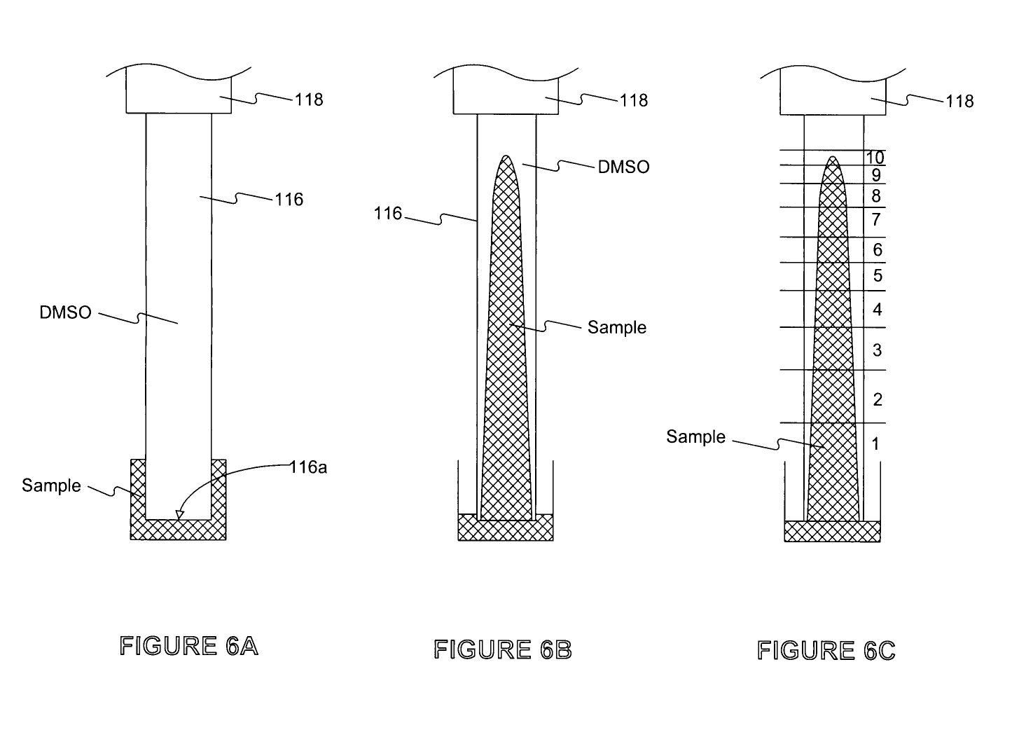

The sample that has been aspirated into the first tubes 116 is diluted in the solvent (DMSO) within the tube as it is dispersed into a parabolic flow profile. The method of the present invention is based upon volume fractions of the dispersion curve of the sample caused by the two flow profiles in and out of the tube (see FIGS. 6B and 6C). This diluted sample can be dispensed (in volumes that have been predetermined by calibration, as shown in the above tables) into the remaining columns or rows of vessels to create the dilution series. Thus, unlike serial dilution and direct deposit, there is only one aspiration step followed by at least one dispensing step, and generally between 1 and 40 dispensing steps. For example, in a 10 point dilution series, there is one aspiration step followed by nine dispensing steps. There is no need to spend time mixing the wells because subsequent deposits are independent of previous wells.

Alternatively, it is also possible to make a dilution series that includes only the sample and a single dilution. In such a case, there is one aspiration step and at least one dispensing step. Depending upon the desired dilution, it may be necessary to dispense a portion of the aspirated sample into waste before dispensing a portion of the aspirated sample into the destination dilution well.

An example of a method of producing a ten point, 100 μL final volume, 2:1 dilution series in a microtiter plate using the system 100 according to the present invention will now be described. To begin, a 96 well plate with 200 μL of sample in each well of a first column, i.e., column 1, is placed in the input area 104 of the vertical stacker 102. A 2:1 dilution series, ten points, 100 μL final volume is selected from a protocol list on a computer connected to the system. The computer provides the proper parameters to the motors that drive the banks of syringe pumps.

The wash station is extended under the first tube tips 116a. The first tube tips 116a are lowered into the wash station. The first and second banks 120, 122 of syringe pumps aspirate 500 μL of solvent (DMSO) from the solvent feed 124, the 2-way valves switch and the syringes empty through to the first and second tubes 116,118, thus priming them. The first tube tips 116a are raised and the wash station 126 is retracted. The plate 106 is moved by the stacker on track portion 108 to the fluid manifold 112. The first bank 120 of syringe pumps aspirates 400 μL of solvent (DMSO) from the solvent feed 124. The second bank 122 of syringe pumps aspirates 500 μL of solvent (DMSO) from the solvent feed 124. The first tubes 116 are lowered into the first column of the plate 106. The first bank 120 of syringe pumps aspirates 100 μL of the sample from each of the wells in column 1 of the plate 106 into the first tubes 116. As the sample is aspirated into the tubes 116, it is diluted as it is dispersed in the solvent by moving through the DMSO in the first tubes 116.

The first tubes tips 116a are raised out of the wells in column 1 and the stacker 102 moves the plate 106 to position a second column, i.e., column 2, below the first tubes 116. The tips 116a of the first tubes 116 are lowered to an appropriate height in the wells in column 2 of plate 106. The first bank 120 dispenses a portion, fraction, or “slice” of the dispersed sample (56 μL) into the wells in column 2 through first tubes 116 as substantially simultaneously the second bank 122 dispenses solvent (44 μL) into the wells in column 2 through second tubes 118. As the solvent is dispensed through second tubes 118, it washes over the tips 116a of first tubes 116. As it washes over tips 116a, the solvent aids in removing hanging droplets that contribute to carryover error.

The first tubes 116 then are raised out of the wells in column 2 and the stacker 102 moves the plate 106 to position a third column, i.e., column 3, below the first tubes 116. The tips 116a of the first tubes 116 are lowered to an appropriate height in the wells in column 3 of plate 106. The first bank 120 dispenses some of the dispersed sample (40 μL) into the wells in column 3 through first tubes 116 as substantially simultaneously the second bank 122 dispenses solvent (60 μL) into the wells in column 3 through second tubes 118 and over the tips 116a of first tubes 116.

Next, the first tubes 116 are raised out of the wells in column 3 and the stacker 102 moves the plate 106 or track portion 108 to position a fourth column, i.e., column 4, below the first tubes 116. The tips 116a of the first tubes 116 are lowered to an appropriate height in the wells in column 4 of plate 106; the dispersed sample (37 μL) is dispensed into the wells in column 4 through first tubes 116 as substantially simultaneously solvent (63 μL) is dispensed into the wells in column 4 through second tubes 118.

The first tubes 116 then are raised out of the wells in column 4 and the stacker 102 moves the plate 106 on track portion 108 to position a fifth column, i.e., column 5, below the first tubes 116. The tips 116a of the first tubes 116 are lowered to an appropriate height in the wells in column 5 of plate 106. The first bank 120 dispenses the dispersed sample (33 μL) into the wells in column 5 through first tubes 116 as substantially simultaneously the second bank 122 dispenses solvent (67 μL) into the wells in column 5 through second tubes 118.

The first tubes 116 are raised out of the wells in column 5 and the stacker moves the plate 106 to position a sixth column, i.e., column 6, below the first tubes 116. The second bank 122 of syringe pumps aspirates 500 μL of DMSO from the solvent feed. The tips 116a of the first tubes 116 are lowered to an appropriate height in the wells in column 6 of plate 106 and the next “slice” of the dispensed sample (24 μL) is dispensed into the wells in column 6 through first tubes 116. Substantially simultaneously, the second bank 122 dispenses solvent (76 μL) into the wells in column 6 through second tubes 118.

Next, the first tubes 116 then are raised out of the wells in column 6 and the stacker 102 moves the plate 106 to position a seventh column, i.e., column 7, below the first tubes 116. The tips 116a of the first tubes 116 are lowered to an appropriate height in the wells in column 7 of plate 106. The first bank 120 dispenses the dispersed sample (16 μL) into the wells in column 7 through first tubes 116 as substantially simultaneously the second bank 122 dispenses solvent (84 μL) into the wells in column 7 through second tubes 118.

The first tubes 116 then are raised out of the wells in column 7 and the stacker 102 moves the plate 106 to position an eighth column, i.e., column 8, below the first tubes 116. The tips 116a of the first tubes 116 are lowered to an appropriate height in the wells in column 8 of plate 106. The first bank 120 dispenses the next “slice” of the dispersed sample (10.5 μL) into the wells in column 8 through first tubes 116 as substantially simultaneously the second bank 122 dispenses solvent (89.5 μL) into the wells in column 8 through second tubes 118.

The first tubes 116 are raised out of the wells in column 8 and the stacker 102 moves the plate 106 to position a ninth column, i.e., column 9, below the first tubes 116. The tips 116a of the first tubes 116 are lowered to an appropriate height in the wells in column 9 of plate 106. The first bank 120 dispenses the dispersed sample (6 μL) into the wells in column 9 through first tubes 116 as substantially simultaneously the second bank 122 dispenses solvent (94 μL) into the wells in column 9 through second tubes 118.

Finally, the first tubes 116 are raised out of the wells in column 9 and the stacker 102 moves the plate 106 to position a tenth column, i.e., column 10, below the first tubes 116. The tips 116a of the first tubes 116 are lowered to an appropriate height in the wells in column 10 of plate 106. The first bank 120 dispenses the dispersed sample (3.2 μL) into the wells in column 10 through first tubes 116 as substantially simultaneously the second bank 122 dispenses solvent (96.8 μL) into the wells in column 10 through second tubes 118. The tips 116a of the first tubes 116 are raised out of the wells in column 10 and the stacker 102 moves the plate 106 to the output area 110 of the stacker 110.

A wash station 126 is then extended across the track portion 108 of the stacker 102 and positioned beneath the manifold 112. The tips 116a of the first tubes 116 are lowered into the wash station 126 and all syringes of both the first and second banks 120,122 of syringe pumps are filled with solvent and flushed four times. Waste in the wash station is removed by vacuum (not shown) to a waste collection receptacle (not shown) via a drain line 128.

Although the examples provided herein perform the dilution series across columns of vessels, it is also possible that the dilution series may be performed across rows of vessels. In addition, while the examples suggest aspirating one half of the volume of the sample in the vessels, the invention permits the aspiration of sufficient sample to repeat the dispensing step at least once without repeating the aspiration step. Preferably, sufficient sample is aspirated to permit completion of the dilution series without aspirating additional sample and the present invention has been used to make between 1 and 40 dilution steps.

An example of a method of producing a dilution series in a 384 well plate using the system 100 according to the present invention will now be described. The total volume range, per well, for a 384 well plate is much smaller then for a 96 well plate well, as the wells are approximately 4 times larger in the 96 well format (96 well=300 μL total and 384=80 μL total). Many dilution series can be constructed, but two examples are shown here: a 10 point dilution series and a 22 point dilution series.

To begin a 10 point dilution series in a 384 well plate, sample is added to each well of column 1, (for a total of 16 samples as a 384 well plate is 16 rows by 24 columns). In this example, sample is also added to each well in column 13 for plate total of 32 samples. It should be noted that the column numbers (i.e., column 1, column 13) may change dependent upon the number and placement of control columns used, if any. The samples in column 1 are then diluted by lowering the tips 116a of first tubes 116 into column 1 and aspirating the sample into the first tubes 116, which have been primed with solvent. The set of eight tips 116a is spaced for a 96 well plate, which means that each of the tips 116a is lowered into every other well in column 1, e.g., into wells A1, C1, E1, G1, I1, K1, M1, O1. The dilution series is then created by diluting each sample across the plate. For example, the sample found in column 1, row A (well A1) will be diluted into wells A2, A3, A4, A5, A6, A7, A8, A9, A10. The tips 116a are then washed and the y-axis of the manifold 112 is offset to lower the tips into the alternate wells (e.g., wells B1, D1, F1, H1, J1, L1, N1, P1). The dilution is then carried out across the plate as described above. This process is continued using column 13 as the sample source column for the second half of the plate. In essence this format yields the same arrangement of dilution series as 96 well format, but at 4× density. As mentioned above, upon plate completion, certain columns (columns 11, 12, 23 and 24 in this example) may be blank for subsequent addition of assay controls. The method may differ slightly for dilution series using a 384 well plate (from that used for a 96 well plate) in that, after each dispensing step, the tips 116a may be lowered again to touch the surface of the fluid in the wells to remove any droplets on the tips 116a.

To begin a 22 point dilution series in a 384 well plate, sample is added to each well of column 1 (for a total of 16 samples). The samples in column 1 are diluted by lowering the tips 116a of tubes 116 into column 1 to access every other well, and the samples are aspirated into tubes 116, diluting the samples by dispersion in the tubes 116. The dilution plate is then created by dispensing the dispersed/diluted sample across the plate into columns 2-22 of the 384 well plate. It should be noted that the column numbers may change dependent upon the number and placement of control columns used, if any. In this example, columns 23 and 24 may be left blank for subsequent addition of assay controls. The process continues by washing the tips 116a, offsetting the manifold 112 along the y-axis, and diluting the samples in the wells that were missed the first time.

The wash station 126 is then extended across the track portion 108 of the stacker 102 and positioned beneath the manifold 112. The tips 116a of the first tubes 116 are lowered into the wash station 126 and all syringes of both the first and second banks 120,122 of syringe pumps are filled with solvent and flushed twice. Waste in the wash station is removed by vacuum to a waste collection receptacle.

A method of producing a dilution series according to the present invention and using a conventional commercial liquid handler such as the Tecan Genesis RS 200 will now be described. As previously discussed, conventional commercial liquid handlers do not include a second conduit. The absence of a second conduit requires pre-dispensing of the diluent into the microtiter plate prior to making the dilutions as opposed to simultaneously dispensing the diluent with the dispersed sample. As used herein, the terms “buffer,” “solvent,” and “diluent” are intended to be interchangable.

To begin, a microtiter plate is provided and a first column of wells includes, for example, approximately 100 μL of sample in each well. The amount of sample may vary as long as there is sufficient sample to be aspirated and to complete the dilution series. The desired dilution series and final volume are selected from a protocol list on a computer connected to the system. The computer provides the proper parameters to the motors that drive the banks of syringe pumps. Using the first tubes 216 (see FIG. 8), solvent/buffer is transferred from a supply reservoir (not shown) into the columns of wells of the microtiter plate that will contain the dilution series (destination wells) to act as diluent. For example, each well may be filled with about 99 μL to about 100 μL of solvent/buffer. The actual amount of solvent/buffer put in the destination wells will vary dependent upon the final dilution desired. The greater the dilution desired, the larger the amount of solvent/buffer that should be added to the destination wells. Again using the first tubes 216, solvent/buffer is transferred from the supply reservoir into a column of wells such that each well contains, for example, approximately 100 μL of solvent/buffer to be used as a rinse or dip to wash off the outside of the tubes 216. More or less solvent/buffer may be used as necessary.

To begin the dilution, the first tubes 216 are primed by aspirating, for example, approximately 50 μL of the diluent into the tubes 216 from the supply reservoir. Depending upon the dilution desired, different amounts of the diluent may be aspirated. Next, from the first column of wells, the sample is aspirated into the tubes 216, for example, approximately 5 μL to approximately 10 μL of sample is aspirated. The amount of sample aspirated will depend upon the dilution factor selected. As the sample is aspirated into the tubes 216, it is diluted as it is dispersed in the solvent/buffer by moving through the diluent in the first tubes 216. Subsequently, a portion of the dispersed sample (i.e., the aspirated sample and diluent) is dispensed into a waste trough, for example, about 10 μL to about 15 μL is dispensed into waste. The exact amount dispensed to waste also will vary depending upon the dilution factor selected. The greater the dilution desired, the larger the amount of the dispersed sample that will be dispensed to waste. After dispensing a portion of the dispersed sample to waste, the tips of the first tubes 216 are dipped into the column of wells designated as a rinse trough and containing the solvent/buffer to rinse off the outside of the tubes 216 and any external droplets of sample/diluent that may be on the outside of the tubes 216.

After rinsing, the tubes 216 dispense a portion of the dispersed sample into the first column of destination wells to form the first column of dilutions. For example, between about 0.5 μL and about 1.0 μL of the dispersed sample may be dispensed into each well in the first column of the destination wells. Subsequently, the dispensing step is repeated, for example three times, to create each additional dilution in the dilution series (i.e., from 1 to n dilutions in the series, where n=4 in the above example) to create additional dilutions in the dilution series. It should be noted that n may represent a very small number of dilutions or a very large number of dilutions. After creating the dilution series, the tubes 216 are flushed and their tips are washed.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of creating a dilution series, comprising:
providing a plurality of vessels, wherein at least a first vessel includes a sample;
aspirating at least a portion of the sample from at least the first vessel into at least one first conduit primed with solvent such that the sample disperses in the solvent;
dispensing at least a portion of the dispersed sample from the at least one first conduit into at least a second vessel; and
substantially simultaneously dispensing a solvent into at least the second vessel from at least one second conduit.

2. The method of claim 1, wherein the at least one second conduit is positioned relative to the at least one first conduit such that fluid exiting said at least one second conduit is directed around at least a tip portion of the at least one first conduit, and wherein substantially simultaneously dispensing a solvent includes permitting the solvent to flow over at least the tip portion of the at least one first conduit.

3. The method of claim 1, wherein the at least one first conduit passes through the at least one second conduit, and wherein substantially simultaneously dispensing a solvent includes permitting the solvent to flow over a tip of the at least one first conduit.

4. The method of claim 1, further comprising repeating the steps of dispensing and substantially simultaneously dispensing without repeating the aspirating step.

5. The method of claim 1, wherein aspirating at least a portion of the sample includes aspirating an amount of sample sufficient to perform an entire dilution series.

6. The method of claim 1, wherein aspirating at least a portion of the sample from at least the first vessel into at least one first conduit primed with solvent such that the sample disperses in the solvent includes the sample taking on a substantially parabolic flow profile as it moves through the at least one first conduit.

7. The method of claim 1, wherein aspirating at least a portion of the sample from at least the first vessel into at least one first conduit primed with solvent such that the sample disperses in the solvent includes at least partially dispersing the sample in the solvent by at least convection and diffusion.

8. The method of claim 1, wherein the step of dispensing a portion of the dispersed sample is performed at a first dilution factor, and further comprising the steps of:
changing the dilution factor; and
subsequent to changing the dilution factor, dispensing another portion of the dispersed sample from the at least one conduit into at least a third vessel.

9. A system for creating a dilution series, comprising:
at least one first conduit configured to aspirate and dispense a sample to be diluted;
a first pressure source, configured to prime the at least one first conduit with a solvent and configured to aspirate a sample into the primed first conduit, wherein the first pressure source provides laminar flow conditions that cause the sample to disperse in the solvent in the at least one first conduit;
at least one second conduit configured to dispense a solvent;
a second pressure source for dispensing a solvent from the at least one second conduit; and
a controller configured to instruct said first and second pressure sources to dispense said aspirated sample and said solvent at substantially the same time.

10. The system of claim 9, wherein the at least one second conduit is positioned relative to the at least one conduit such that fluid exiting said at least one second conduit is directed around at least a tip of the at least one first conduit.

11. The system of claim 9, wherein the at least one first conduit passes through the at least one second conduit.

12. The system of claim 11, wherein a tip of the at least one first conduit extends below a tip of the at least one second conduit, such that fluid exiting said at least one second conduit moves over at least the tip of the at least one first conduit.

13. The system of claim 9, wherein the at least one first conduit includes a plurality of first conduits and the at least one second conduit includes a plurality of second conduits, and wherein each first conduit is nested within a respective second conduit.

14. A method of creating a dilution series, comprising:
providing a plurality of vessels;
providing a sample in at least a first vessel;
aspirating at least a portion of the sample into at least one first conduit;
permitting the aspirated sample to disperse into solvent contained within the at least one first conduit, wherein dispersion of the sample occurs at least by convection;
dispensing at least a portion of the dispersed sample from the at least one first conduit into at least a second vessel; and
dispensing a solvent into at least the second vessel from at least one second conduit.

15. The method of claim 14, further comprising repeating the steps of dispensing at least a portion of the dispersed sample and dispensing a solvent without repeating the aspirating step.

16. The method of claim 15, wherein repeating the steps of dispensing at least a portion of the dispersed sample and dispensing a solvent without repeating the aspirating step includes repeating the steps a plurality of times.

17. The method of claim 14, wherein permitting the aspirated sample to disperse into solvent contained within the at least one conduit by at least convection further includes at least partially dispersing the sample in the solvent by diffusion.

18. The method of claim 14, wherein permitting the aspirated sample to disperse into solvent contained within the at least one conduit by at least convection includes the sample taking on a substantially parabolic flow profile as it moves through the at least one first conduit.

19. A method of creating a dilution series using a pressure driven pumping syringe based liquid handler, comprising:
providing a plurality of vessels, wherein at least a first vessel includes a sample and at least a second vessel includes a diluent;
aspirating a diluent into at least one conduit;
aspirating at least a portion of the sample from at least the first vessel into the at least one conduit containing the aspirated diluent such that the sample disperses in the diluent; and
dispensing at least a portion of the dispersed sample from the at least one conduit into at least the second vessel containing the diluent to form a dilution of the sample.

20. The method of claim 19, further comprising repeating the step of dispensing without repeating the aspirating steps.

21. The method of claim 20, wherein repeating the step of dispensing without repeating the aspirating steps includes repeating the dispensing step a plurality of times.

22. The method of claim 19, wherein aspirating at least a portion of the sample includes aspirating an amount of sample sufficient to perform an entire dilution series.

23. The method of claim 19, wherein aspirating at least a portion of the sample from at least the first vessel into at least one conduit containing the aspirated diluent such that the sample disperses in the diluent includes the sample taking on a substantially parabolic flow profile as it moves through the at least one conduit.

24. The method of claim 19, wherein aspirating at least a portion of the sample from at least the first vessel into at least one conduit containing the aspirated diluent such that the sample disperses in the diluent includes at least partially dispersing the sample in the diluent by at least convection and diffusion.

25. A method of creating a dilution series using a pressure driven pumping syringe based liquid handler, comprising:
providing a plurality of vessels, wherein at least a first vessel includes a sample and at least a second vessel includes a diluent;
aspirating at least a portion of the sample into at least one conduit;
permitting the aspirated sample to disperse into diluent contained within the at least one conduit;
dispensing a first portion of the dispersed sample from the at least one conduit into a waste receptacle; and
dispensing a second portion of the dispersed sample from the at least one conduit into at least the second vessel.

26. The method of claim 25, further comprising repeating the step of dispensing a second portion of the dispersed sample without repeating the aspirating step.

27. The method of claim 25, wherein aspirating at least a portion of the sample includes aspirating an amount of sample sufficient to repeat the step of dispensing at least a second portion of the dispersed sample at least once without repeating the aspirating step.

28. The method of claim 25, wherein permitting the aspirated sample to disperse into diluent contained within the at least one conduit includes at least partially dispersing the sample in the diluent by diffusion.

29. The method of claim 25, wherein permitting the aspirated sample to disperse into diluent contained within the at least one conduit includes at least partially dispersing the sample in the diluent by convection.

30. The method of claim 25, wherein the step of dispensing a second portion of the dispersed sample is performed at a first dilution factor, and further comprising the steps of:
changing the dilution factor; and
subsequent to changing the dilution factor, dispensing a third portion of the dispersed sample from the at least one conduit into at least a third vessel.

31. The method of claim 25, further comprising aspirating the diluent into the at least one conduit prior to aspirating the sample.
